(19) United States
(12) Patent Application Publication
(10) Pub. No.: US 2025/0197210 A1
(43) Pub. Date: Jun. 19, 2025

(54) HYDROGEN PRODUCTION APPARATUS AND METHOD THEREFOR

(71) Applicants: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(72) Inventors: Ha Eun Jeong, Hwaseong-si (KR); Young Gul Hur, Hwaseong-si (KR); Pyung Soon Kim, Hwaseong-si (KR); Kyung Soo Park, Hwaseong-si (KR); Ji Yong Kim, Hwaseong-si (KR)

(73) Assignees: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(21) Appl. No.: 18/806,075

(22) Filed: Aug. 15, 2024

(30) Foreign Application Priority Data
Dec. 13, 2023 (KR) 10-2023-0181247

(51) Int. Cl. C01B 3/34; B01D 53/00; B01D 53/047; B01D 53/22; B01J 12/00; B01J 19/00; B01J 19/24; C01B 3/50; C01B 3/56

(52) U.S. Cl. CPC C01B 3/34; B01D 53/002; B01D 53/047; B01D 53/22; B01J 12/00; B01J 19/0013; B01J 19/245; C01B 3/501; C01B 3/506; C01B 3/56; B01D 2256/16; B01D 2256/20; B01D 2257/504; B01D 2258/025; B01J 2208/00256; B01J 2208/00274; C01B 2203/0233; C01B 2203/0405; C01B 2203/042; C01B 2203/046; C01B 2203/047; C01B 2203/1241; C01B 2203/1264; C01B 2203/86

(57) ABSTRACT

A hydrogen production apparatus includes a first separation device that separates hydrogen from a steel by-product gas and discharges a first mixed gas containing carbon monoxide and methane, a pre-reforming device that receives the first mixed gas and a first water vapor, converts hydrocarbon into methane, and discharges a second mixed gas containing the methane, a mixed reforming device that receives the second mixed gas and a second water vapor and discharges a third mixed gas containing the hydrogen and the carbon monoxide, and a second separation device that individually separates the hydrogen and the carbon monoxide from the third mixed gas.

### CROSS REFERENCE TO RELATED APPLICATIONS

This application claims the benefit of priority to Korean Patent Application No. 10-2023-0181247, filed in the Korean Intellectual Property Office on Dec. 13, 2023, the entire contents of which are incorporated herein by reference.

### TECHNICAL FIELD

The present disclosure relates to a hydrogen production apparatus and a method therefore, and more particularly, to a technology that may reduce carbon dioxide discharge while increasing energy efficiency.

### BACKGROUND

To practice carbon neutrality to respond to climate change, efforts are being made in the industry to reduce greenhouse gas discharge. Among them, since the steel industry discharges a significant amount of greenhouse gases, measures for reducing the greenhouse discharge are further required.

To reduce carbon discharge from steel by-product gases, a technology is proposed in which a mixed gas of hydrogen and carbon monoxide is used as a reducing gas for iron ore. However, in the technology in which the mixed gas is used as the reducing gas, after the carbon monoxide is reduced, carbon dioxide is inevitably discharged, and thus there is a limitation in that the carbon dioxide corresponding to the greenhouse gases is discharged.

Thus, a method capable of efficiently reducing the carbon discharge while utilizing the steel by-product gas is required.

### SUMMARY

The present disclosure has been made to solve the above-mentioned problems occurring in the prior art while advantages achieved by the prior art are maintained intact.

An aspect of the present disclosure provides a hydrogen production apparatus and a method therefor, which may generate a high-value compound using a steel by-product gas.

Further, another aspect of the present disclosure provides a hydrogen production apparatus and a method therefor, which may reduce the amount of carbon discharged in a process of generating hydrogen using the steel by-product gas.

Further, still another aspect of the present disclosure provides a hydrogen production apparatus and a method therefor, which may increase energy efficiency in a hydrogen production process.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a hydrogen production apparatus includes a first separation device that separates hydrogen from a steel by-product gas and discharges a first mixed gas containing carbon monoxide and methane, a pre-reforming device that receives the first mixed gas and a first water vapor, converts hydrocarbon into methane, and discharges a second mixed gas containing the methane, a mixed reforming device that receives the second mixed gas and a second water vapor and discharges a third mixed gas containing the hydrogen and the carbon monoxide, and a second separation device that individually separates the hydrogen and the carbon monoxide from the third mixed gas.

According to an embodiment, the first separation device may separate the hydrogen from a cock oven gas (COG) and discharge the first mixed gas.

According to an embodiment, the hydrogen production apparatus may further include a pretreatment device that pretreats impurities contained in the COG and provides the pretreated COG to the first separation device.

According to an embodiment, the first separation device or the second separation device may use at least one of a pressure swing adsorption method, a separation membrane method, or a cryogenic separation method.

According to an embodiment, the second separation device may further include a temperature-increasing heat exchanger that separates the carbon monoxide.

According to an embodiment, the pre-reforming device may further perform a process of removing a residual sulfur component of the first mixed gas.

According to an embodiment, the mixed reforming device may perform a mixed reforming reaction based on the methane, carbon dioxide, and the second water vapor and generate the hydrogen and the carbon monoxide.

According to an embodiment, the hydrogen production apparatus may further include a first heat exchanger that increases temperatures of the first mixed gas to a high temperature by using the high-temperature first water vapor.

According to an embodiment, the hydrogen production apparatus may further include a second heat exchanger that increases a temperature of the second mixed gas using heat energy generated by a heat supply device.

According to an embodiment, the hydrogen production apparatus may further include a third heat exchanger that is positioned at a rear end of the mixed reforming device and phase-changes water provided from the outside into the high-temperature second water vapor.

According to an embodiment, the hydrogen production apparatus may further include a fourth heat exchanger that is positioned at the rear end of the mixed reforming device and phase-changes water provided from the outside into the high-temperature first water vapor.

According to an embodiment, the hydrogen production apparatus may further include a collection device that collects carbon dioxide from the first mixed gas passing through the first heat exchanger.

According to an embodiment, the mixed reforming device may receive the carbon dioxide collected by the collection device and use the carbon dioxide for a mixed reforming reaction.

According to another aspect of the present disclosure, a hydrogen production method includes discharging a first mixed gas containing carbon monoxide and methane by separating hydrogen from a steel by-product gas, receiving the first mixed gas and a first water vapor, converting hydrocarbon into methane, and generating a second mixed gas containing the methane, generating a third mixed gas containing the hydrogen and the carbon monoxide by receiving the second mixed gas and a second water vapor, and individually separating the hydrogen and the carbon monoxide from the third mixed gas.

According to an embodiment, in the discharging of the first mixed gas, the hydrogen may be separated from a cock oven gas (COG).

According to an embodiment, the individually separating of the hydrogen and the carbon monoxide from the third mixed gas may include separating the hydrogen using a pressure swing adsorption method, a separation membrane method, or a cryogenic separation method.

According to an embodiment, the individually separating of the hydrogen and the carbon monoxide from the third mixed gas may further include increasing a temperature using a heat exchanger and then separating the carbon monoxide.

According to an embodiment, the generating of the third mixed gas may include generating the hydrogen and the carbon monoxide by performing a mixed reforming reaction based on the methane, carbon dioxide, and the second water vapor.

According to an embodiment, the hydrogen production method may further include collecting carbon dioxide from the first mixed gas.

According to an embodiment, in the generating of the third mixed gas, the carbon dioxide collected from the first mixed gas may be provided, and the third mixed gas may be generated based on the carbon dioxide and the methane contained in the second mixed gas.

### BRIEF DESCRIPTION OF THE FIGURES

The above and other objects, features and advantages of the present disclosure will be more apparent from the following detailed description taken in conjunction with the accompanying drawings:

FIG. 1 is a view for describing a configuration of a hydrogen production apparatus according to an embodiment of the present disclosure;

FIG. 2 is a flowchart for describing a hydrogen production method according to the embodiment of the present disclosure;

FIG. 3 is a view illustrating the hydrogen production apparatus according to the embodiment of the present disclosure;

FIG. 4 is a view illustrating a hydrogen production apparatus according to another embodiment of the present disclosure; and

FIGS. 5 and 6 are views illustrating a hydrogen production apparatus according to a comparative example.

### DETAILED DESCRIPTION

Hereinafter, some embodiments of the present disclosure will be described in detail with reference to the exemplary drawings. In adding reference numerals to components of each drawing, it should be noted that identical or equivalent components are designated by an identical numeral even when they are displayed on other drawings. Further, in describing the embodiment of the present disclosure, a detailed description of the related known configuration or function will be omitted when it is determined that the detailed description interferes with the understanding of the embodiment of the present disclosure.

In the description of the components of the embodiments of the present disclosure, the terms such as first, second, A, B, (a) and (b) may be used. These terms are merely intended to distinguish one component from other components, and the terms do not limit the nature, order, or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

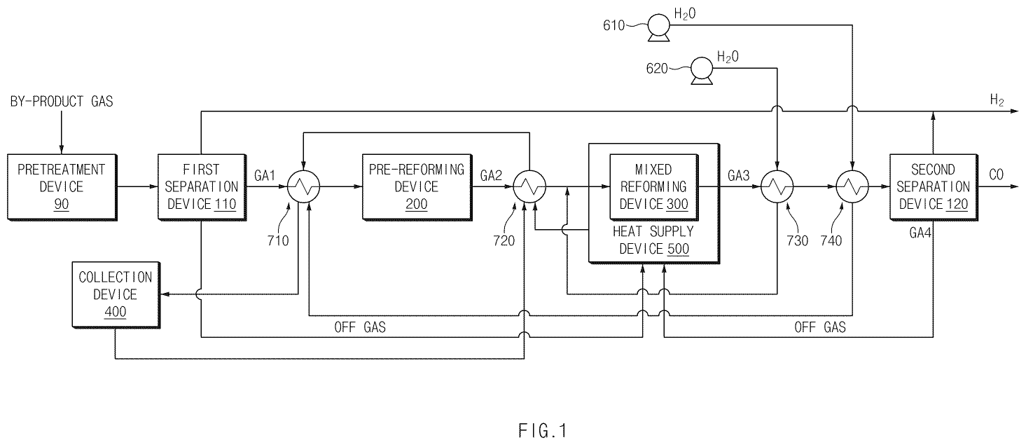

Hereinafter, embodiments of the present disclosure will be described in detail to the reference to FIGS. 1 to 6.

FIG. 1 is a view for describing a configuration of a hydrogen production apparatus according to an embodiment of the present disclosure.

Referring to FIG. 1, the hydrogen production apparatus according to the embodiment of the present disclosure may include a pretreatment device 90, a first separation device 110, a pre-reforming device 200, a mixed reforming device 300, a second separation device 120, and a collection device 400. Further, the hydrogen production apparatus according to the embodiment of the present disclosure may further include a first heat exchanger 710, a second heat exchanger 720, a third heat exchanger 730, and a fourth heat exchanger 740 for adjusting temperatures of mixed gases discharged in respective processes of a hydrogen production process.

The pretreatment device 90 may pre-treat impurities contained in a coke oven gas (COG). The pretreatment device 90 may pre-treat impurities such as tar, ammonia (NH₃), and sulfur (S) contained in the COG through the pretreatment. The pretreatment device 90 may provide the COG from which the impurities are removed to the first separation device 110.

The first separation device 110 may separate hydrogen from the steel by-product gas and discharge a first mixed gas GA1 containing carbon monoxide and methane.

The steel by-product gas may be the COG. The COG may be a gas generated while a bituminous coal is dried in a cock oven and may be a by-product gas containing methane CH₄. The COG may be a gas containing hydrogen H₂, carbon monoxide CO, carbon dioxide CO₂, nitrogen N₂, tar, sulfur, or the like in addition to the methane. For example, a composition ratio of the COG used in the embodiment of the present disclosure may be expressed in Table 1 below

TABLE 1

| | CO | H₂ | CH₄ | CₘHₙ | CO₂ | N₂ | O₂ |
|---|---|---|---|---|---|---|---|
| COG | 6.5 | 55.4 | 24.9 | 2.9 | 2.4 | 7.8 | 0.1 |

The composition ratio expressed in Table 1 may be a volume occupied by each gas per unit volume. For example, the carbon monoxide occupies 6.5% of the total volume.

The first separation device 110 may separate the hydrogen into a gaseous state and individually discharge the separated hydrogen.

The first mixed gas GA1 may be a residual gas obtained after separating the hydrogen from the COG, and the first separation device 110 may provide the first mixed gas GA1 to the pre-reforming device 200.

The separated hydrogen may be discharged and collected to the outside of the hydrogen production apparatus. The first separation device 110 may use a pressure swing adsorption (PSA) method, a separation membrane method, or a cryogenic separation method using a cold box.

The first heat exchanger 710 may be adapted to heat the first mixed gas GA1 discharged from the first separation device 110 to a high temperature. The first heat exchanger 710 may perform heat exchange between a high-temperature first water vapor provided from the fourth heat exchanger 740 and the first mixed gas GA1 to increase the temperature of the first mixed gas GA1. The first water vapor may be obtained by phase-changing water provided from a first pump 610 into the high-temperature water vapor.

The pre-reforming device 200 may receive the first mixed gas GA1 and the first water vapor to perform a pre-reforming process. The pre-reforming process may include a process of converting hydrocarbon contained in the first mixed gas GA1 into the methane.

Further, the pre-reforming device 200 may discharge a second mixed gas GA2 containing the methane.

Further, the pre-reforming device 200 may convert components having a carbon number of two or more into the hydrogen and the methane.

Further, the pre-reforming device 200 may remove residual sulfur components contained in the first mixed gas GA1.

The pre-reforming device 200 may perform the pre-reforming process in a temperature range of 300° C. to 600° C.

The second heat exchanger 720 may be adapted to increase a temperature of the second mixed gas GA2 discharged from the pre-reforming device 200. The second heat exchanger 720 may increase the temperature of the second mixed gas GA2 using heat energy provided from a heat supply device 500.

The mixed reforming device 300 may receive the second mixed gas GA2 and a second water vapor to generate a third mixed gas GA3 containing hydrogen and carbon monoxide.

A mixed reforming process performed by the mixed reforming device 300 may be expressed in Equation 1 below.

$$3 {CH}_{4} + {CO}_{2} + 2 {H}_{2} O \to 4 CO + 8 {H}_{2} , Δ H = 659 kJ / mol \qquad Equation 1$$

As may be seen from [Equation 1], the mixed reforming process may include a process of generating carbon monoxide using carbon dioxide as a reactant. Thus, the mixed reforming device 300 according to the embodiment of the present disclosure may generate hydrogen and carbon monoxide while reducing a discharge amount of carbon dioxide.

The mixed reforming process may be performed in a temperature range of 700° C. to 1000° C., and for example, may be performed in a temperature range of 800° C. to 900° C. Further, the mixed reforming process may be performed in a pressure range of 1 bar to 30 bar, and for example, may be performed in a pressure range of 1 bar to 15 bar.

The third mixed gas GA3 generated by the mixed reforming process may contain hydrogen and carbon monoxide and contain unreacted methane and unreacted carbon dioxide.

The third heat exchanger 730 may be positioned at a rear end of the mixed reforming device 300 and may phase-change water provided through a second pump 620 into the high-temperature first water vapor.

The fourth heat exchanger 740 may be located between the mixed reforming device 300 and the third heat exchanger 730 and may phase-change the water provided through the first pump 610 into high temperature second water vapor.

The second separation device 120 may individually separate hydrogen and carbon monoxide from the third mixed gas.

The hydrogen separated by the second separation device 120 may be discharged through the same path as that of the hydrogen separated by the first separation device 110. The second separation device 120 may separate the hydrogen using the PSA method, the separation membrane method, or the cryogenic separation method using the cold box.

A hydrogen gas and a carbon monoxide gas separated by the second separation device 120 may be individually collected and commercialized.

The second separation device 120 may discharge a fourth mixed gas GA4 obtained after separating the hydrogen gas and the carbon monoxide gas.

The heat supply device 500 may be adapted to provide heat energy to the mixed reforming device 300 and may be a burner that generates heat energy by combusting hydrogen and carbon monoxide. The heat supply device 500 may use the fourth mixed gas GA4 provided from the second separation device 120 as a combustion material.

The collection device 400 may be a device that collects carbon dioxide from the first mixed gas GA1 of the first heat exchanger 710.

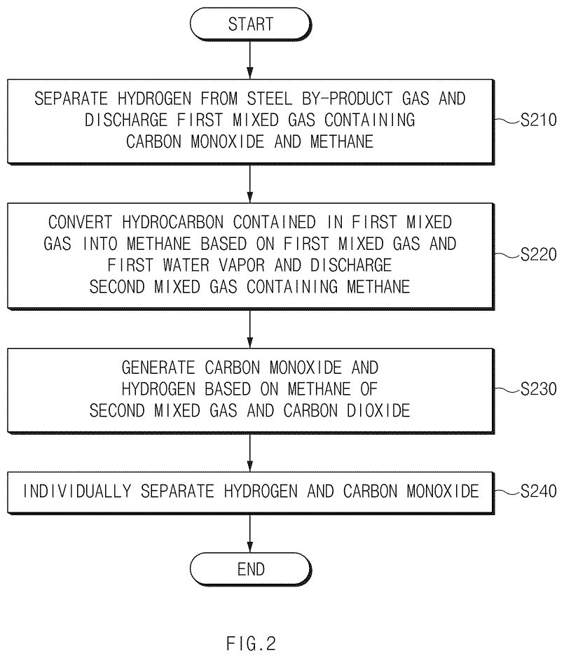

FIG. 2 is a flowchart for describing a hydrogen production method according to the embodiment of the present disclosure. The hydrogen production method according to the embodiment of the present disclosure will be described below with reference to FIGS. 1 and 2.

In operation S210, the first separation device 110 may separate the hydrogen from the steel by-product gas and discharge the first mixed gas GA1 containing the carbon monoxide and the methane.

The steel by-product gas may be the COG and may correspond to a state in which impurities are removed by the pretreatment device 90.

In operation S220, the pre-reforming device 200 may receive the first mixed gas GA1 and the first water vapor to convert the hydrocarbon into the methane and discharge the second mixed gas GA2 containing the methane.

The first water vapor may be a high-temperature water vapor provided from the first heat exchanger 710.

In operation S230, the mixed reforming device 300 may receive the second mixed gas GA2 and the second water vapor, which are discharged from the pre-reforming device 200, to generate the third mixed gas GA3 containing the hydrogen and the carbon monoxide. The mixed reforming process may be a process of generating the carbon monoxide and the hydrogen using the methane contained in the second mixed gas GA2, the carbon dioxide, and the second water vapor.

The second water vapor may be a high-temperature water vapor provided from the third heat exchanger 730.

In operation S240, the second separation device 120 may individually separate the hydrogen and the carbon monoxide of the third mixed gas GA3.

The second separation device 120 may discharge the hydrogen and the carbon monoxide through different paths.

Hereinafter, an embodiment of the hydrogen production apparatus according to the embodiment of the present disclosure will be described in more detail below.

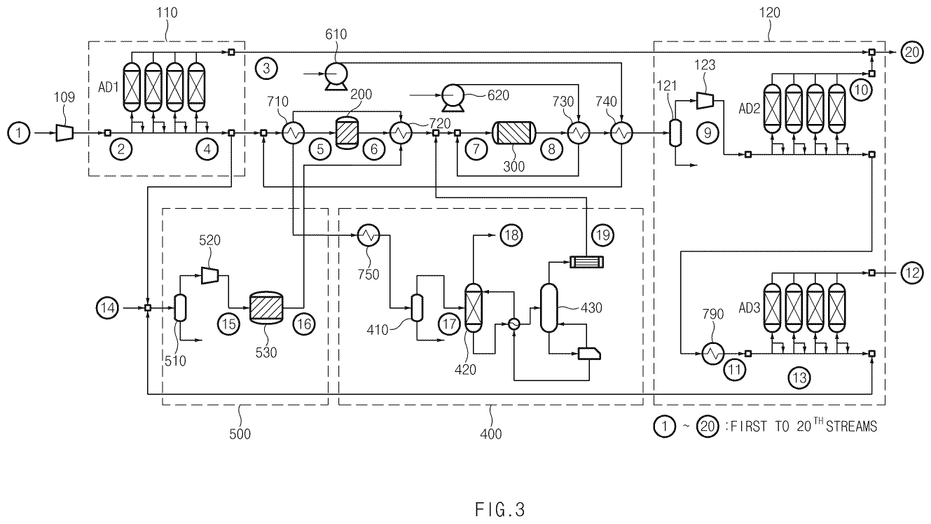

FIG. 3 is a view illustrating the hydrogen production apparatus according to the embodiment of the present disclosure. Table 2 below is a table illustrating an example of a process condition and a material composition in each of streams of pipes illustrated in FIG. 3. In table 2, T may mean temperature (° C.), P may mean Pressure (bar), Mass_F may mean Mass Flows (kg/hr), Mole_F may mean Mole Flows (kmol/hr). A unit for H2, CO, CO2, H2O, CH4, C2H6, O2, and N2 may be kmol/hr.

TABLE 2

| | T | P | Mass_F | Mole_F | H2 | CO | CO2 | H2O | CH4 | C2H6 | O2 | N2 |
|---|---|---|---|---|---|---|---|---|---|---|---|---|
| 1 | 30 | 1.0 | 377 | 34 | 19 | 2 | 1 | 0 | 8 | 1 | 0 | 3 |
| 2 | 35 | 15.0 | 377 | 34 | 19 | 2 | 1 | 0 | 8 | 1 | 0 | 3 |
| 3 | 35 | 1.0 | 34 | 17 | 17 | 0 | 0 | 0 | 0 | 0 | 0 | 0 |
| 4 | 35 | 15.0 | 342 | 17 | 2 | 2 | 1 | 0 | 8 | 1 | 0 | 3 |
| 5 | 371 | 5.0 | 458 | 24 | 1 | 2 | 1 | 10 | 7 | 1 | 0 | 2 |
| 6 | 550 | 5.0 | 458 | 26 | 6 | 1 | 3 | 7 | 7 | 0 | 0 | 2 |
| 7 | 680 | 5.0 | 624 | 35 | 6 | 1 | 3 | 17 | 7 | 0 | 0 | 2 |
| 8 | 900 | 5.0 | 624 | 49 | 27 | 8 | 2 | 10 | 0 | 0 | 0 | 2 |
| 9 | 35 | 15.0 | 450 | 40 | 27 | 8 | 2 | 0 | 0 | 0 | 0 | 2 |
| 10 | 35 | 1.0 | 49 | 24 | 24 | 0 | 0 | 0 | 0 | 0 | 0 | 0 |
| 11 | 60 | 9.0 | 401 | 16 | 3 | 8 | 2 | 0 | 0 | 0 | 0 | 2 |
| 12 | 60 | 9.0 | 205 | 7 | 0 | 7 | 0 | 0 | 0 | 0 | 0 | 0 |
| 13 | 60 | 9.0 | 196 | 8 | 3 | 1 | 2 | 0 | 0 | 0 | 0 | 2 |
| 14 | 35 | 15.0 | 219 | 7 | 0 | 0 | 0 | 0 | 0 | 0 | 7 | 0 |
| 15 | 35 | 30.0 | 485 | 19 | 3 | 1 | 3 | 0 | 2 | 0 | 7 | 3 |
| 16 | 1000 | 5.0 | 458 | 26 | 6 | 1 | 3 | 7 | 7 | 0 | 0 | 2 |
| 17 | 40 | 1.0 | 360 | 10 | 0 | 0 | 6 | 1 | 0 | 0 | 0 | 3 |
| 18 | 68 | 1.0 | 96 | 3 | 0 | 0 | 0 | 0 | 0 | 0 | 0 | 3 |
| 19 | 27 | 1.0 | 264 | 6 | 0 | 0 | 6 | 0 | 0 | 0 | 0 | 0 |
| 20 | 35 | 1.0 | 83 | 41 | 41 | 0 | 0 | 0 | 0 | 0 | 0 | 0 |

The hydrogen production apparatus and method according to the embodiment of the present disclosure will be described below with reference to FIG. 3 and Table 2.

The hydrogen production apparatus according to the embodiment of the present disclosure may include the pretreatment device 90, the first separation device 110, the pre-reforming device 200, the mixed reforming device 300, the second separation device 120, and the collection device 400. Further, the hydrogen production apparatus according to a first embodiment of the present disclosure may further include the first heat exchanger 710, the second heat exchanger 720, the third heat exchanger 730, and the fourth heat exchanger 740.

A first stream may be the COG from which impurities are removed by the pretreatment device 90.

The first separation device 110 may separate hydrogen from the steel by-product gas and discharge the first mixed gas GA1 containing carbon monoxide and methane. The first separation device 110 may include a first compressor 109 and a plurality of first adsorbers AD1.

The first compressor 109 may increase a pressure of the first stream, and the pressure-increased first stream may be provided to the first adsorbers AD1.

The first adsorber AD1 may be a container accommodating an adsorbent that separates and purifies the hydrogen, and the adsorbent may be a material for adsorbing impurity gases from a second stream containing impurities.

The hydrogen separated by the first adsorbers AD1 may be collected to a third stream.

Further, a fourth stream in which the hydrogen is separated from the COG may be provided to the first heat exchanger 710. The fourth stream may be the first mixed gas GA1 illustrated in FIG. 1.

The first heat exchanger 710 may receive the fourth stream and the first water vapor passing through the fourth heat exchanger 740 and increase the temperature of the fourth stream. The temperature-increased fourth stream and a fifth stream containing the first water vapor may be provided to the pre-reforming device 200.

In the fifth stream, the pre-reforming device 200 may convert components having a carbon number of two or more into hydrogen and methane. Further, in the fifth stream, the pre-reforming device 200 may remove residual sulfur components.

The second heat exchanger 720 may increase a temperature of a sixth stream discharged from the pre-reforming device 200 in a heat exchange manner. To this end, the second heat exchanger 720 may receive heat energy from the heat supply device 500. The sixth stream may be the second mixed gas GA2 illustrated in FIG. 1.

The temperature of the sixth stream may increase based on the second water vapor provided from the third heat exchanger 730.

The temperature-increased sixth stream and a seventh stream containing the second water vapor may be provided to the mixed reforming device 300.

The mixed reforming device 300 may generate carbon monoxide and hydrogen through a mixed reforming reaction.

The eighth stream discharged from the mixed reforming device 300 may be the third mixed gas GA3 illustrated in FIG. 1.

The eighth stream may be cooled through heat exchange with water provided from the first pump 610 and the second pump 620 while passing through the third heat exchanger 730 and the fourth heat exchanger 740.

The second separation device 120 may individually separate the hydrogen and the carbon monoxide from the eighth stream passing through the fourth heat exchanger 740 and may include a first gas-liquid separator 121, a second compressor 123, a plurality of second adsorbers AD2, and a sixth heat exchanger 790.

The first gas-liquid separator 121 may separate residual moisture and a C₂ or higher compound from the eighth stream of which a temperature decreases while passing through the third heat exchanger 730 and the fourth heat exchanger 740.

The second compressor 123 may increase a pressure of the eighth stream passing through the first gas-liquid separator 121. The second compressor 123 may increase the pressure of the eighth stream in a normal pressure state to about 30 bar.

A ninth stream of which a pressure is increased by the second compressor 123 may be provided to the second adsorbers AD2.

The hydrogen separated by the second adsorbers AD2 may be collected to a tenth stream. The tenth stream may be joined with the third stream discharged from the first separation device 110 and may be discharged to a 20^{th} stream.

The sixth heat exchanger 790 may collect carbon monoxide from the gas from which the hydrogen is separated in the ninth stream.

A 13^{th} stream from which the carbon monoxide is separated in a 11^{th} stream may be provided to the heat supply device 500.

The heat supply device 500 may be adapted to provide heat energy to the second heat exchanger 720 and may include a second gas-liquid separator 510, a third compressor 520, and a combustion reactor 530.

The second gas-liquid separator 510 of the heat supply device 500 may receive the hydrogen and the carbon monoxide contained in the 13^{th} stream as combustion materials. Further, the second gas-liquid separator 510 may receive a 14^{th} stream containing oxygen (O₂). The second gas-liquid separator 510 may separate residual moisture and a C₂ or higher compound in the 13^{th} stream and the 14^{th} stream. Further, the second gas-liquid separator 510 may receive the fourth stream from the first separation device 110, and the hydrogen and the carbon monoxide contained in the fourth stream may be used as combustion materials.

The third compressor 520 may compress a gas passing through the second gas-liquid separator 510 and provide the compressed gas to the combustion reactor 530.

The combustion reactor 530 may be a burner that supplies heat energy to the mixed reforming device 300. A 15^{th} stream provided to the combustion reactor 530 may include hydrogen and carbon monoxide, and the combustion reactor 530 may combust the hydrogen and the carbon monoxide to generate heat energy.

A high-temperature 16^{th} stream discharged from the combustion reactor 530 may be provided to the second heat exchanger 720.

The collection device 400 may be a device that collects carbon dioxide from the first mixed gas GA1 of the first heat exchanger 710. The collection device 400 may include a fifth heat exchanger 750, a third gas-liquid separator 410, a carbon dioxide collector 420, and a carbon dioxide separator 430.

The fifth heat exchanger 750 may provide residual heat from the first heat exchanger 710 to the third gas-liquid separator 410.

The third gas-liquid separator 410 may separate residual moisture and a C₂ or higher compound from a gas passing through the fifth heat exchanger 750.

A 17^{th} stream passing through the third gas-liquid separator 410 may be provided to the carbon dioxide collector 420. The carbon dioxide collector 420 may collect carbon dioxide in the 17^{th} stream, and to this end, the carbon dioxide collector 420 may use monoethanolamine as a collector. A gas containing the carbon dioxide that is collected by the carbon dioxide collector 420 may be provided to the carbon dioxide separator 430. A residual gas separated in the carbon dioxide collector 420 may be discharged to an 18^{th} stream.

The carbon dioxide separator 430 may receive the gas containing the carbon dioxide from the carbon dioxide collector 420 and extract carbon dioxide at higher purity from the supplied gas. The carbon dioxide separated in the carbon dioxide separator 430 may be discharged to a 19^{th} stream.

Further, the carbon dioxide separated in the carbon dioxide separator 430 may be provided to the mixed reforming device 300. In this way, in the hydrogen production apparatus according to the embodiment of the present disclosure, since the carbon dioxide generated during the hydrogen production process is recycled to the hydrogen production process, the amount of carbon dioxide discharged may be reduced.

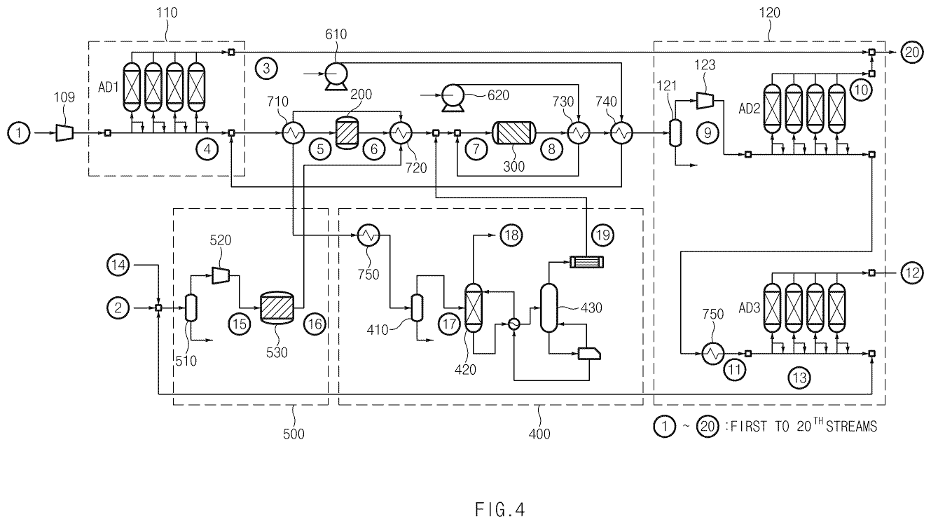

FIG. 4 is a view illustrating a hydrogen production apparatus according to another embodiment of the present disclosure.

In the hydrogen production apparatus illustrated in FIG. 4, the oxygen is supplied to the heat supply device 500 through the 14^{th} stream, and a Linze Donawitz gas (LDG) is supplied through the second stream.

A composition ratio of the LDG according to the embodiment of the present disclosure may be expressed in Table 3 below.

TABLE 3

| | CO | H2 | CO2 | N2 | O2 |
|---|---|---|---|---|---|
| LDG | 53.5 | 1.2 | 17.6 | 26.9 | 0.1 |

As expressed in Table 3, the LDG may be a gas having a carbon monoxide content of about 53% and containing carbon dioxide and nitrogen as main compositions.

Table 4 below is a table illustrating an example of a process condition and a material composition in each of streams of pipes illustrated in FIG. 4 when the LDG is used as a combustion material. In table 4, T may mean temperature (° C.), P may mean Pressure (bar), Mass_F may mean Mass Flows (kg/hr), Mole_F may mean Mole Flows (kmol/hr). A unit for H₂, CO, CO2, H2O, CH4, C2H6, O2, and N2 may be kmol/hr.

TABLE 4

| | T | P | Mass_F | Mole_F | H2 | CO | CO2 | H2O | CH4 | C2H6 | O2 | N2 |
|---|---|---|---|---|---|---|---|---|---|---|---|---|
| 1 | 30 | 1.0 | 377 | 34 | 19 | 2 | 1 | 0 | 8 | 1 | 0 | 3 |
| 2 | 30 | 1.0 | 550 | 18 | 0 | 10 | 3 | 0 | 0 | 0 | 0 | 5 |
| 3 | 35 | 1.0 | 34 | 17 | 17 | 0 | 0 | 0 | 0 | 0 | 0 | 0 |
| 4 | 35 | 15.0 | 342 | 17 | 2 | 2 | 1 | 0 | 8 | 1 | 0 | 3 |
| 5 | 458 | 5.0 | 531 | 27 | 2 | 2 | 1 | 10 | 8 | 1 | 0 | 3 |
| 6 | 550 | 5.0 | 531 | 29 | 6 | 1 | 3 | 7 | 9 | 0 | 0 | 3 |
| 7 | 672 | 5.0 | 818 | 45 | 6 | 1 | 3 | 23 | 9 | 0 | 0 | 3 |
| 8 | 900 | 5.0 | 818 | 64 | 34 | 10 | 3 | 14 | 0 | 0 | 0 | 3 |
| 9 | 35 | 15.0 | 574 | 51 | 34 | 10 | 3 | 0 | 0 | 0 | 0 | 3 |
| 10 | 35 | 1.0 | 62 | 31 | 31 | 0 | 0 | 0 | 0 | 0 | 0 | 0 |
| 11 | 60 | 9.0 | 512 | 20 | 3 | 10 | 3 | 0 | 0 | 0 | 0 | 3 |
| 12 | 60 | 9.0 | 255 | 9 | 0 | 9 | 0 | 0 | 0 | 0 | 0 | 0 |
| 13 | 60 | 9.0 | 257 | 11 | 3 | 1 | 3 | 0 | 0 | 0 | 0 | 3 |
| 14 | 35 | 15.0 | 241 | 8 | 0 | 0 | 0 | 0 | 0 | 0 | 8 | 0 |
| 15 | 35 | 30.0 | 1046 | 36 | 4 | 11 | 6 | 0 | 2 | 0 | 8 | 7 |
| 16 | 1000 | 30.0 | 1046 | 29 | 0 | 0 | 17 | 4 | 0 | 0 | 0 | 7 |
| 17 | 40 | 1.0 | 1006 | 27 | 0 | 0 | 17 | 2 | 0 | 0 | 0 | 7 |
| 18 | 68 | 1.0 | 267 | 9 | 0 | 0 | 1 | 1 | 0 | 0 | 0 | 7 |
| 19 | 27 | 1.0 | 739 | 17 | 0 | 0 | 16 | 1 | 0 | 0 | 0 | 0 |
| 20 | 35 | 1.0 | 96 | 48 | 48 | 0 | 0 | 0 | 0 | 0 | 0 | 0 |

The hydrogen production apparatus and method according to another embodiment of the present disclosure will be described below with reference to FIG. 4, Table 3, and Table 4. In the following embodiment, detailed description of configurations that are substantially the same as the embodiments described based on FIG. 3 will be omitted.

The hydrogen production apparatus according to another embodiment of the present disclosure may include the pretreatment device 90, the first separation device 110, reforming devices 200 and 300, the second separation device 120, the collection device 400, and the heat supply device 500. Further, the hydrogen production apparatus according to the first embodiment of the present disclosure may further include the first heat exchanger 710, the second heat exchanger 720, the third heat exchanger 730, and the fourth heat exchanger 740.

The first separation device 110 may separate hydrogen from a first steel by-product gas and discharge a first mixed gas containing carbon monoxide and methane. The first steel by-product gas may be the COG.

The heat supply device 500 may generate heat energy using a second steel by-product gas as a combustion material and provide the generated heat energy to the reforming devices 200 and 300. The second steel by-product gas may be the LDG.

The reforming devices 200 and 300 may include the pre-reforming device 200 and the mixed reforming device 300.

The 13^{th} stream from which the carbon monoxide is separated in the 11^{th} stream may be provided to the heat supply device 500.

The second gas-liquid separator 510 of the heat supply device 500 may receive the hydrogen and the carbon monoxide contained in the 13^{th} stream as combustion materials. Further, the second gas-liquid separator 510 may receive the 14^{th} stream containing the oxygen.

The second gas-liquid separator 510 according to another embodiment of the present disclosure may receive the second stream containing the LDG. The LDG may be a gas having a high carbon monoxide content of about 53% and may be used as a heat source for the heat supply device 500.

The second gas-liquid separator 510 may separate residual moisture and a C₂ or higher compound in the second stream, the 13^{th} stream, and the 14^{th} stream.

The mixed reforming device 300 may require a high temperature of about 700° C. to 1000° C. for the mixed reforming reaction. In another embodiment of the present disclosure, the heat supply device 500 may be driven using the LDG as a combustion material, thereby efficiently producing heat energy. In particular, in the hydrogen production apparatus according to another embodiment of the present disclosure, since the LDG that is one of by-product gases is used as a heat source, a carbon-containing gas discharged to the atmosphere may be reduced.

In the hydrogen production apparatus illustrated in FIG. 4, the second stream may contain a blast furnace gas (BFG), which may be used as a combustion material. Hereinafter, an embodiment in which the BFG is used as a combustion material will be described below.

A method of generating the hydrogen using the BFG as a combustion material may use the hydrogen production apparatus illustrated in FIG. 4.

Table 5 below is a table illustrating a composition ratio of the BFG that is used as a combustion material through the second stream.

TABLE 5

| | CO | H₂ | CO₂ | N₂ | O₂ |
|---|---|---|---|---|---|
| BFG | 25.3 | 3.6 | 23.4 | 47.2 | 0.01 |

Table 6 below is a table illustrating a process condition and a material composition in each of the streams of the pipes illustrated in FIG. 4 when the BFG is used as a combustion material. In table 6, T may mean temperature (° C.), P may mean Pressure (bar), Mass_F may mean Mass Flows (kg/hr), Mole_F may mean Mole Flows (kmol/hr). A unit for H2, CO, CO2, H2O, CH4, C2H6, O2, and N2 may be kmol/hr.

TABLE 6

| | T | P | Mass_F | Mole_F | H2 | CO | CO2 | H2O | CH4 | C2H6 | O2 | N2 |
|---|---|---|---|---|---|---|---|---|---|---|---|---|
| 1 | 30 | 1.0 | 377 | 34 | 19 | 2 | 1 | 0 | 8 | 1 | 0 | 3 |
| 2 | 30 | 1.0 | 1328 | 43 | 2 | 11 | 10 | 0 | 0 | 0 | 0 | 20 |
| 3 | 35 | 1.0 | 34 | 17 | 17 | 0 | 0 | 0 | 0 | 0 | 0 | 0 |
| 4 | 35 | 15.0 | 342 | 17 | 2 | 2 | 1 | 0 | 8 | 1 | 0 | 3 |
| 5 | 584 | 5.0 | 531 | 27 | 2 | 2 | 1 | 10 | 8 | 1 | 0 | 3 |
| 6 | 550 | 5.0 | 531 | 29 | 6 | 1 | 3 | 7 | 9 | 0 | 0 | 3 |
| 7 | 715 | 5.0 | 818 | 45 | 6 | 1 | 3 | 23 | 9 | 0 | 0 | 3 |
| 8 | 900 | 5.0 | 818 | 64 | 34 | 10 | 3 | 14 | 0 | 0 | 0 | 3 |
| 9 | 35 | 15.0 | 574 | 51 | 34 | 10 | 3 | 0 | 0 | 0 | 0 | 3 |
| 10 | 35 | 1.0 | 62 | 31 | 31 | 0 | 0 | 0 | 0 | 0 | 0 | 0 |
| 11 | 60 | 9.0 | 512 | 20 | 3 | 10 | 3 | 0 | 0 | 0 | 0 | 3 |
| 12 | 60 | 9.0 | 255 | 9 | 0 | 9 | 0 | 0 | 0 | 0 | 0 | 0 |
| 13 | 60 | 9.0 | 257 | 11 | 3 | 1 | 3 | 0 | 0 | 0 | 0 | 3 |
| 14 | 35 | 15.0 | 283 | 9 | 0 | 0 | 0 | 0 | 0 | 0 | 9 | 0 |
| 15 | 35 | 30.0 | 1867 | 62 | 5 | 12 | 13 | 0 | 0 | 0 | 9 | 23 |
| 16 | 1000 | 30.0 | 1867 | 54 | 0 | 0 | 25 | 5 | 0 | 0 | 0 | 23 |
| 17 | 40 | 1.0 | 1830 | 52 | 0 | 0 | 25 | 3 | 0 | 0 | 0 | 23 |
| 18 | 68 | 1.0 | 745 | 27 | 0 | 0 | 1 | 2 | 0 | 0 | 0 | 23 |
| 19 | 27 | 1.0 | 1086 | 25 | 0 | 0 | 24 | 1 | 0 | 0 | 0 | 0 |
| 20 | 35 | 1.0 | 96 | 48 | 48 | 0 | 0 | 0 | 0 | 0 | 0 | 0 |

The hydrogen production apparatus and method according to another embodiment of the present disclosure will be described below with reference to FIG. 4, Table 5, and Table 6. In the embodiment in which the BFG is used as a combustion material, the hydrogen production apparatus illustrated in FIG. 4 may be used, and thus in description of the following embodiment, a detailed description of the same component will be omitted.

The second gas-liquid separator 510 of the heat supply device 500 may receive the hydrogen and the carbon monoxide contained in the 13^{th} stream as combustion materials. Further, the second gas-liquid separator 510 may receive the 14^{th} stream containing the oxygen.

The second gas-liquid separator 510 according to another embodiment of the present disclosure may receive the second stream containing the BFG.

The BFG may be a gas having a carbon monoxide content of about 25% and may be used as the heat source for the heat supply device 500.

The second gas-liquid separator 510 may separate residual moisture and a C₂ or higher compound in the second stream, the 13^{th} stream, and the 14^{th} stream.

The mixed reforming device 300 may require a high temperature of about 700° C. to 1000° C. for the mixed reforming reaction. In another embodiment of the present disclosure, the heat supply device 500 may be driven using the BFG as a combustion material, thereby efficiently producing heat energy. In particular, in the hydrogen production apparatus according to another embodiment of the present disclosure, since the BFG that is one of by-product gases is used as a heat source, a carbon-containing gas discharged to the atmosphere may be advantageously reduced.

Hereinafter, with regard to a hydrogen production apparatus according to a comparative example, a difference between the comparative example and the above-described examples is described.

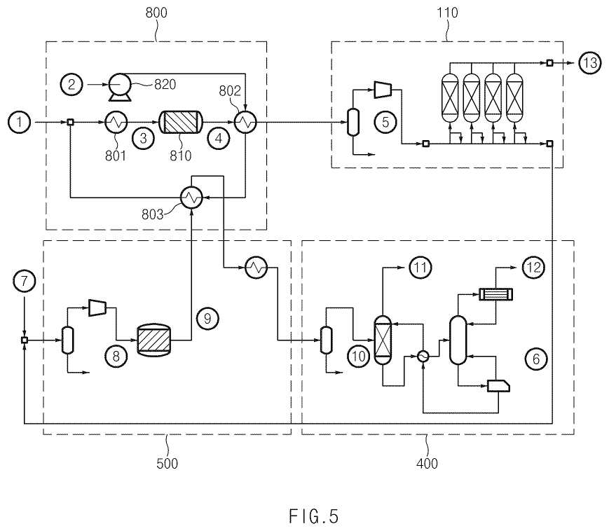

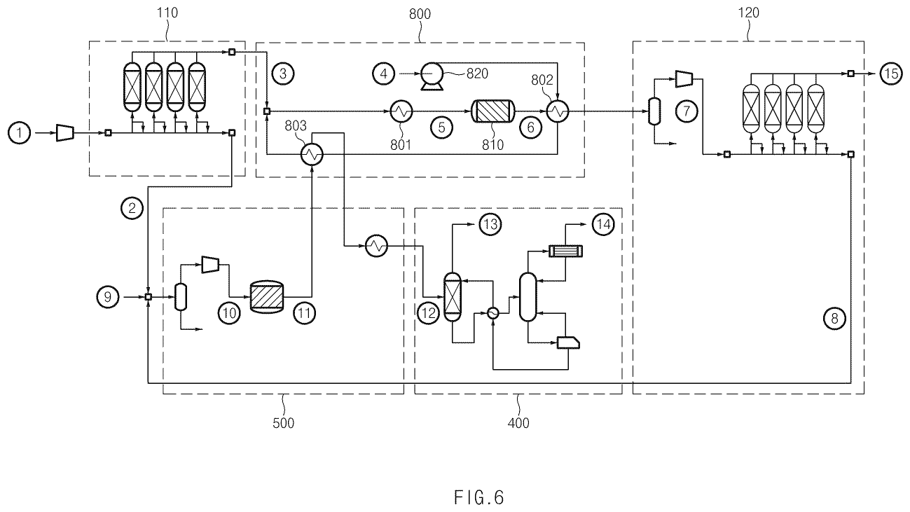

FIGS. 5 and 6 are views illustrating a hydrogen production apparatus according to a comparative example.

FIG. 5 is a view illustrating a hydrogen production apparatus using the LDG, and Table 7 below is a table illustrating a process condition and a material composition of each of the streams in the hydrogen production apparatus illustrated in FIG. 5. In table 7, T may mean temperature (° C.), P may mean Pressure (bar), Mass_F may mean Mass Flows (kg/hr), Mole_F may mean Mole Flows (kmol/hr). A unit for H2, CO, CO2, H2O, CH4, C2H6, O2, and N2 may be kmol/hr.

TABLE 7

| | T | P | Mass_F | Mole_F | H2 | CO | CO2 | H2O | CH4 | C2H6 | O2 | N2 |
|---|---|---|---|---|---|---|---|---|---|---|---|---|
| 1 | 30 | 1.0 | 1039 | 34 | 0 | 18 | 6 | 0 | 0 | 0 | 0 | 9 |
| 2 | 30 | 1.0 | 983 | 55 | 0 | 0 | 0 | 55 | 0 | 0 | 0 | 0 |
| 3 | 230 | 1.0 | 2022 | 89 | 0 | 18 | 6 | 55 | 0 | 0 | 0 | 9 |
| 4 | 434 | 1.0 | 2022 | 89 | 17 | 1 | 23 | 38 | 0 | 0 | 0 | 9 |
| 5 | 35 | 15.0 | 1348 | 51 | 17 | 1 | 23 | 0 | 0 | 0 | 0 | 9 |
| 6 | 35 | 15.0 | 1317 | 36 | 2 | 1 | 23 | 0 | 0 | 0 | 0 | 9 |
| 7 | 35 | 1.0 | 50 | 2 | 0 | 0 | 0 | 0 | 0 | 0 | 2 | 0 |
| 8 | 35 | 30.0 | 1363 | 37 | 2 | 1 | 23 | 0 | 0 | 0 | 2 | 9 |
| 9 | 557 | 30.0 | 1363 | 35 | 0 | 0 | 24 | 2 | 0 | 0 | 0 | 9 |
| 10 | 40 | 1.0 | 1363 | 35 | 0 | 0 | 24 | 2 | 0 | 0 | 0 | 9 |
| 11 | 68 | 1.0 | 359 | 12 | 0 | 0 | 2 | 1 | 0 | 0 | 0 | 9 |
| 12 | 27 | 1.0 | 1004 | 23 | 0 | 0 | 22 | 1 | 0 | 0 | 0 | 0 |
| 13 | 35 | 1.0 | 31 | 16 | 16 | 0 | 0 | 0 | 0 | 0 | 0 | 0 |

The hydrogen production apparatus according to the comparative example will be described below with reference to FIG. 5 and Table 7.

The hydrogen production apparatus according to the comparative example may include a water-gas transfer reaction device 800, the first separation device 110, the heat supply device 500, and the collection device 400.

The water-gas transfer reaction device 800 may include first to third heat exchangers 801, 802, and 803, a pump 820, and a reactor 810.

The first stream may be LDG in which impurities such as tar, ammonia, and sulfur are pretreated and may be input into the first heat exchanger 801. Water provided from the pump 820 may be phase-changed into water vapor via the second heat exchanger 802, and a temperature of the water vapor may increase via the third heat exchanger 803. The temperatures of the first stream and the high-temperature water vapor may increase via the first heat exchanger, and the first stream and the high-temperature water vapor may be input into the reactor 810.

A water-gas transfer reaction may be performed in the reactor 810, and the water-gas transfer reaction may be expressed as Equation 2 below.

$$CO + {H}_{2} O \to {CO}_{2} + {H}_{2} , Δ H = - 41 kJ / mol \qquad Equation 2$$

The stream in which the water-gas transfer reaction is completed may be provided to the first separation device 110, and the first separation device 110 may separate the hydrogen and collect the separated hydrogen to the 13^{th} stream.

The heat supply device 500 may produce heat energy by combusting a heat source provided through the seventh stream.

The collection device 400 may collect carbon dioxide from the stream in which the water-gas transfer reaction is completed.

FIG. 6 is a view illustrating a hydrogen production apparatus using the BFG, and Table 8 below is a table illustrating a process condition and a material composition of each of the streams in the hydrogen production apparatus illustrated in FIG. 6. In table 8, T may mean temperature (° C.), P may mean Pressure (bar), Mass_F may mean Mass Flows (kg/hr), Mole_F may mean Mole Flows (kmol/hr). A unit for H2, CO, CO2, H2O, CH4, C2H6, O2, and N2 may be kmol/hr.

TABLE 8

| | T | P | Mass_F | Mole_F | H2 | CO | CO2 | H2O | CH4 | C2H6 | O2 | N2 |
|---|---|---|---|---|---|---|---|---|---|---|---|---|
| 1 | 30 | 1.0 | 1049 | 34 | 1 | 9 | 8 | 0 | 0 | 0 | 0 | 16 |
| 2 | 60 | 9.0 | 796 | 25 | 1 | 1 | 7 | 0 | 0 | 0 | 0 | 16 |
| 3 | 60 | 9.0 | 252 | 9 | 0 | 8 | 1 | 0 | 0 | 0 | 0 | 0 |
| 4 | 30 | 1.0 | 418 | 23 | 0 | 0 | 0 | 23 | 0 | 0 | 0 | 0 |
| 5 | 230 | 1.0 | 671 | 32 | 0 | 8 | 1 | 23 | 0 | 0 | 0 | 0 |
| 6 | 466 | 1.0 | 671 | 32 | 7 | 1 | 8 | 16 | 0 | 0 | 0 | 0 |
| 7 | 35 | 15.0 | 382 | 16 | 7 | 1 | 8 | 0 | 0 | 0 | 0 | 0 |
| 8 | 35 | 15.0 | 369 | 9 | 1 | 1 | 8 | 0 | 0 | 0 | 0 | 0 |
| 9 | 35 | 1.0 | 54 | 2 | 0 | 0 | 0 | 0 | 0 | 0 | 2 | 0 |
| 10 | 35 | 30.0 | 1219 | 36 | 2 | 1 | 15 | 0 | 0 | 0 | 2 | 16 |
| 11 | 658 | 30.0 | 1219 | 35 | 0 | 0 | 17 | 2 | 0 | 0 | 0 | 16 |
| 12 | 40 | 1.0 | 1219 | 35 | 0 | 0 | 17 | 2 | 0 | 0 | 0 | 16 |
| 13 | 68 | 1.0 | 553 | 19 | 0 | 0 | 2 | 1 | 0 | 0 | 0 | 16 |
| 14 | 27 | 1.0 | 666 | 15 | 0 | 0 | 15 | 1 | 0 | 0 | 0 | 0 |
| 15 | 35 | 1.0 | 13 | 7 | 7 | 0 | 0 | 0 | 0 | 0 | 0 | 0 |

The hydrogen production apparatus according to another comparative example will be described below with reference to FIG. 6 and Table 8. A detailed description of a configuration that is substantially the same as that of the hydrogen production apparatus according to the comparative example illustrated in FIG. 5 will be omitted in the comparative example illustrated in FIG. 6.

The hydrogen production apparatus according to another comparative example may include the first separation device 110, the water-gas transfer reaction device 800, the second separation device 120, the heat supply device 500, and the collection device 400.

The first stream may be the BFG in which impurities such as tar, ammonia, and sulfur are pretreated. Since the BFG has a lower carbon monoxide content than that of LDG, carbon monoxide may be separated using the first separation device 110. The third stream containing carbon monoxide separated by the first separation device 110 may be input into the water-gas transfer reaction device 800. A configuration of the water-gas transfer reaction device 800 may be the same as that according to the comparative example illustrated in FIG. 5. Further, the first separation device 110 and the second separation device 120 illustrated in FIG. 6 may have the same configuration as the first separation device 110 illustrated in FIG. 5, and the heat supply device 500 and collection device 400 may have the same configuration as those of the heat supply device 500 and the collection device 400 illustrated in FIG. 5.

A carbon dioxide discharge amount in the example illustrated in FIG. 4 and the comparative examples illustrated in FIGS. 5 and 6 will be described below.

Table 9 below is a table illustrating carbon dioxide discharge amounts according to a first comparative example and a second comparative example in addition to the first example and the second example. Table 9 may be a table illustrating carbon dioxide discharge amounts based on the same hydrogen production amount.

TABLE 9

| | | | | First | |
|---|---|---|---|---|---|
| | | | Second | Comparative | Second |
| | | First Example | Example | Example | Comparative |
| | | (Using | (Using | (Using | Example |
| | Unit | COG + LDG) | COG + BFG) | LDG) | (Using BFG) |
| 1) Feed CO₂ | kgCO₂eq/y | −10,083,160 | −12,810,748 | −9,361,259 | −6,071,803 |
| reduction | | | | | |
| amount | | | | | |
| 2) Utility | kgCO₂eq/y | 3,362,714 | 4,690,145 | 4,798,629 | 3,090,678 |
| discharge CO₂ | | | | | |
| Facility power | kgCO₂eq/y | 982,530 | 1,086,904 | 954,117 | 823,478 |
| High- | | 0 | 0 | 622,147 | 57,364 |
| temperature | | | | | |
| high-pressure | | | | | |
| water vapor | | | | | |
| Low- | | 2,380,184 | 3,603,242 | 3,222,365 | 2,209,836 |
| temperature | | | | | |
| low-pressure | | | | | |
| water vapor | | | | | |
| 3) CO₂ | kgCO₂eq/y | 241,736 | 357,694 | 595,774 | 582,969 |
| discharged | | | | | |
| after reaction | | | | | |
| 4) collected | kgCO₂eq/y | 5,909,024 | 8,557,253 | 8,030,080 | 5,330,224 |
| CO₂ | | | | | |
| 5) H₂ produced | kgH₂/y | 769,600 | 769,618 | 250,904 | 105,397 |
| after reaction | | | | | |

In Table 9, the first example may be an example in which the hydrogen is produced using the COG and the LDG based on the hydrogen production apparatus illustrated in FIG. 4, and the second example may be an example in which the hydrogen is produced using the COG and the BFG based on the hydrogen production apparatus illustrated in FIG. 4. The first comparative example may be the comparative example illustrated in FIG. 5, and the second comparative example may be the comparative example illustrated in FIG. 6.

Table 9 may be a result based on all the used carbon dioxide, the discharged carbon dioxide, and the collected carbon dioxide in the entire process. The carbon dioxide contained in the by-product gas may be consumed in the reaction, and thus may be calculated as a reduction amount.

As may be seen in Table 9, according to the example of the present disclosure, it may be identified that a carbon dioxide discharge amount is low compared to the comparative example and a hydrogen production amount is 2.5 to 8 times greater than that according to the comparative example.

Further, energy efficiency according to the example of the present disclosure and energy efficiency according to the comparative example will be described below. The energy efficiency EEF may refer to a degree to which carbon and energy are stored in a product in the entire process and may be calculated through Equation 3 below.

$$Energy efficiency ( \% ) = \frac{Product energy}{Input energy + Utility power} \times 100 \qquad Equation 3$$

In Equation 3, a utility power amount may mean electricity, heat, and cooling energy.

It is identified that the energy efficiency according to the first example is about 70% and the energy efficiency according to the second example is 62% or more. However, it is identified that both the energy efficiencies according to the first comparative example and the second comparative example are less than 30%. That is, it may be expected that the energy efficiency according to the example of the present disclosure is more than twice that according to the comparative example.

According to an embodiment of the present disclosure, hydrogen may be produced based on a steel by-product gas using a carbon dioxide mixed reforming reaction.

Further, according to the embodiment of the present disclosure, the finally produced carbon dioxide is recovered and is used in a mixed reforming reaction again, and thus carbon discharged may be reduced.

Further, according to the embodiment of the present disclosure, energy efficiency of a hydrogen production process may increase using an off gas discharged in the hydrogen production process as a heat source.

In addition, various effects directly or indirectly identified though the present document may be provided.

The above description is merely illustrative of the technical spirit of the present disclosure, and those skilled in the art to which the present disclosure belongs may make various modifications and changes without departing from the essential features of the present disclosure.

Thus, the embodiments disclosed in the present disclosure are not intended to limit the technology spirit of the present disclosure but are intended to describe the present disclosure, and the scope of the technical spirit of the present disclosure is not limited by these embodiments. The scope of protection of the present disclosure should be interpreted by the appended claims, and all technical spirits within the scope equivalent thereto should be interpreted as being included in the scope of the present disclosure.

1. A hydrogen production apparatus comprising:
a first separation device configured to separate hydrogen from a steel by-product gas and to discharge a first mixed gas containing carbon monoxide and methane;
a pre-reforming device configured to receive the first mixed gas and a first water vapor, to convert hydrocarbon into methane, and to discharge a second mixed gas containing the methane;
a mixed reforming device configured to receive the second mixed gas and a second water vapor and to discharge a third mixed gas containing the hydrogen and the carbon monoxide; and
a second separation device configured to individually separate the hydrogen and the carbon monoxide from the third mixed gas.

2. The hydrogen production apparatus of claim 1, wherein the first separation device is configured to separate the hydrogen from a cock oven gas (COG) and to discharge the first mixed gas.

3. The hydrogen production apparatus of claim 2, further comprising:
a pretreatment device configured to pretreat impurities contained in the COG and to provide the COG to the first separation device.

4. The hydrogen production apparatus of claim 2, wherein the first separation device or the second separation device is configured to use at least one of a pressure swing adsorption method, a separation membrane method, or a cryogenic separation method.

5. The hydrogen production apparatus of claim 4, wherein the second separation device further comprises a carbon-collecting heat exchanger configured to separate the carbon monoxide.

6. The hydrogen production apparatus of claim 4, wherein the pre-reforming device further is configured to remove a residual sulfur component of the first mixed gas.

7. The hydrogen production apparatus of claim 2, wherein the mixed reforming device is configured to perform a mixed reforming reaction based on the methane, carbon dioxide, and the second water vapor, and to generate the hydrogen and the carbon monoxide.

8. The hydrogen production apparatus of claim 2, further comprising:
a first heat exchanger configured to increase a temperature of the first mixed gas to a high temperature using the first water vapor.

9. The hydrogen production apparatus of claim 8, further comprising:
a second heat exchanger configured to increase a temperature of the second mixed gas using heat energy generated by a heat supply device.

10. The hydrogen production apparatus of claim 9, further comprising:
a third heat exchanger positioned at a rear end of the mixed reforming device and configured to phase-change water provided from an outside into the first water vapor.

11. The hydrogen production apparatus of claim 10, further comprising:
a fourth heat exchanger positioned between the rear end of the mixed reforming device and the third heat exchanger, and configured to phase-change water provided from an outside into the second water vapor.

12. The hydrogen production apparatus of claim 8, further comprising:
a collection device configured to collect carbon dioxide from the first mixed gas passing through the first heat exchanger.

13. The hydrogen production apparatus of claim 12, wherein the mixed reforming device is configured to receive the carbon dioxide collected by the collection device, and to use the carbon dioxide for a mixed reforming reaction.

14. A hydrogen production method comprising:
discharging a first mixed gas containing carbon monoxide and methane by separating hydrogen from a steel by-product gas by a first separating device;
receiving, by a pre-reforming device, the first mixed gas and a first water vapor, converting, by the pre-reforming device, hydrocarbon into methane, and generating, by the pre-reforming device, a second mixed gas containing the methane;
generating a third mixed gas containing the hydrogen and the carbon monoxide by receiving the second mixed gas and a second water vapor; and
individually separating the hydrogen and the carbon monoxide from the third mixed gas by a second separation device.

15. The hydrogen production method of claim 14, wherein in the discharging of the first mixed gas, the hydrogen is separated from a cock oven gas (COG).

16. The hydrogen production method of claim 14, wherein the individually separating of the hydrogen and the carbon monoxide from the third mixed gas includes:
separating the hydrogen using a pressure swing adsorption method, a separation membrane method, or a cryogenic separation method.

17. The hydrogen production method of claim 16, wherein the individually separating of the hydrogen and the carbon monoxide from the third mixed gas further includes:
separating the carbon monoxide using a carbon-collecting heat exchanger.

18. The hydrogen production method of claim 14, wherein the generating of the third mixed gas includes:
generating the hydrogen and the carbon monoxide by performing a mixed reforming reaction based on the methane, carbon dioxide, and the second water vapor.

19. The hydrogen production method of claim 14, further comprising:
collecting carbon dioxide from the first mixed gas.

20. The hydrogen production method of claim 19, wherein, in the generating of the third mixed gas, the carbon dioxide collected from the first mixed gas is provided, and the third mixed gas is generated based on the carbon dioxide and the methane contained in the second mixed gas.
